(19) United States
(12) Patent Application Publication
(10) Pub. No.: US 2011/0055160 A1
(43) Pub. Date: Mar. 3, 2011

(54) COMPUTER READABLE MEDIUM, INFORMATION PROCESSING METHOD AND INFORMATION PROCESSING APPARATUS

(75) Inventor: Atsushi Togo, Kanagawa (JP)

(73) Assignee: FUJI XEROX CO., LTD., TOKYO (JP)

(21) Appl. No.: 12/723,267

(22) Filed: Mar. 12, 2010

(30) Foreign Application Priority Data
Aug. 28, 2009 (JP) 2009-197751

(51) Int. Cl. G06F 17/30

(52) U.S. Cl. 707/640; 707/758; 707/E17.014; 707/E17.005; 707/781

(57) ABSTRACT

A computer readable medium storing a program causing a computer to execute an information process, the information process includes: first outputting at least one piece of element information of management target information from a first record unit to a second record unit, the first and the second record units recording the management target information containing a plurality of pieces of element information; deleting, from the first record unit, at least one piece of element information which is output to the second record unit; determining, upon acceptance of a request for processing the management target information recorded in the first record unit from a user, whether or not element information which is necessary for execution of the processing is recorded in the first record unit; and executing the processing if the element information which is necessary for execution of the processing is recorded in the first record unit.

### CROSS-REFERENCE TO RELATED APPLICATION

This application is based on and claims priority under 35 USC119 from Japanese Patent Application No. 2009-197751 filed on Aug. 28, 2009.

### BACKGROUND

1. Technical Field

This invention relates to a computer readable medium, an information processing method and an information processing apparatus.

2. Related Art

For the case where information in a system may be lost because of trouble of the system, etc., it is known that the information in the system is backed up in an external unit, record media, etc.

### SUMMARY

According to an aspect of the invention, a computer readable medium storing a program causing a computer to execute an information process, the information process includes: first outputting at least one piece of element information of management target information from a first record unit to a second record unit, the first and the second record units recording the management target information containing a plurality of pieces of element information; deleting, from the first record unit, at least one piece of element information which is output to the second record unit; determining, upon acceptance of a request for processing the management target information recorded in the first record unit from a user, whether or not element information which is necessary for execution of the processing is recorded in the first record unit; and executing the processing if the element information which is necessary for execution of the processing is recorded in the first record unit.

### BRIEF DESCRIPTION OF THE DRAWINGS

Exemplary embodiments of the invention will be described in detail based on the following figures, wherein:

FIG. 1 is a conceptual module configuration drawing about a configuration example of an embodiment of the invention;

FIG. 2 is a schematic representation to show a data structure example of a document information table;

FIG. 3 is a schematic representation to show a data structure example of an output destination folder;

FIG. 4 is a schematic representation to show a data structure example of storage location information 400;

FIG. 5 is a flowchart to show a backup processing example according to the embodiment of the invention;

FIG. 6 is a flowchart to show a document processing example according to the embodiment of the invention;

FIG. 7 is a flowchart to show a restoration processing example according to the embodiment of the invention;

FIG. 8 is a flowchart to show a backup processing example when access right information is changed according to the embodiment of the invention;

FIG. 9 is a flowchart to show a backup processing example when access right information is changed according to the embodiment of the invention; and

FIG. 10 is a block diagram to show a hardware configuration example of a computer for implementing the embodiment of the invention.

### DETAILED DESCRIPTION

A preferred embodiment to embody the invention will be discussed with reference to the accompanying drawings.

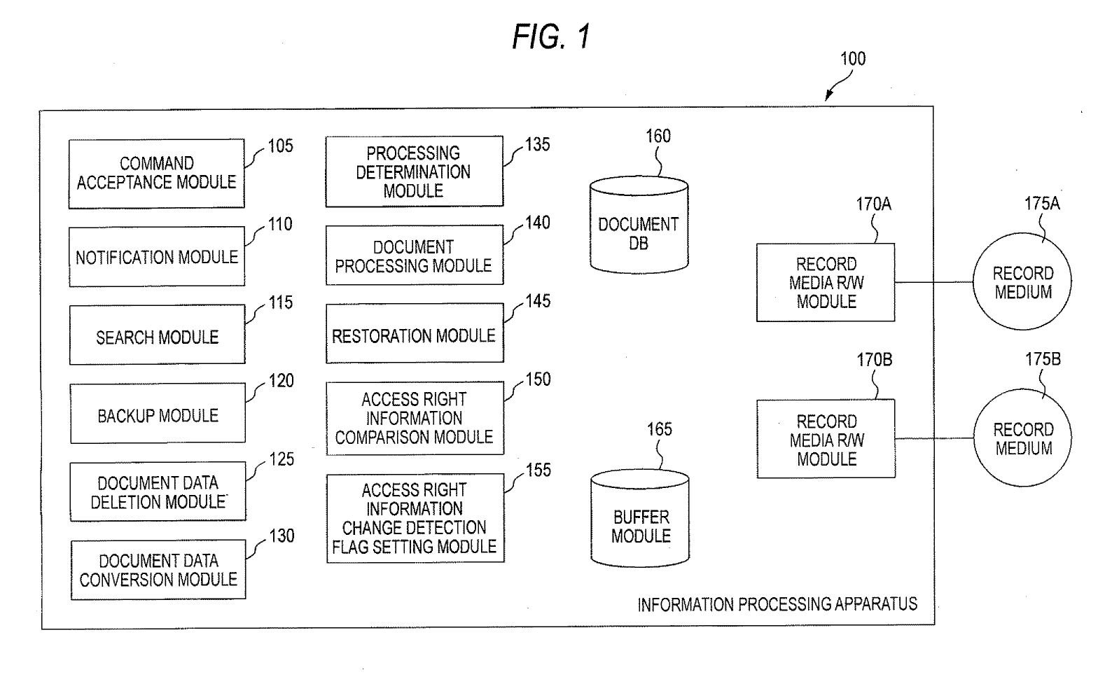

FIG. 1 is a conceptual module configuration drawing about a configuration example of the embodiment of the invention.

A module refers to a generally and logically detachable component of software (computer program), hardware, etc. Therefore, the module in the embodiment means not only a module in a computer program, but also a module in the hardware configuration. Therefore, the embodiment also serves as the description of a computer program, a system, and a method. For the convenience of the description, “record” and its equivalent word are used, however, if the embodiment is a computer program, the words are used to mean recording in a record unit or controlling so as to record in a record unit. Modules are almost in a one-to-one correspondence with functions; however, in implementation, one module may be one program or two or more modules may make up one program or two or more programs may make up one module. Two or more modules may be executed by one computer or one module may be executed in two or more computers in a distributed or parallel environment. One module may contain any other module. In the description to follow, the term “connection” is used for not only physical connection, but also logical connection (data transfer, command, reference relationship between data pieces, etc.).

The system or apparatus is not only provided by connecting a plurality of computers, hardware devices, units, etc., by communication unit such as a network (containing peer-to-peer communication connection), etc., but also implemented as one computer, hardware device, apparatus, etc. “Apparatus” and “system” are used as synonymous terms with each other. The term “predetermined” refers to “determined before the target processing;” it is used not only as meaning before processing of the embodiment is started, but also as meaning determined in response to the situation and the state if the time is before target processing is started or the situation and the state so far even if the time is after processing of the embodiment is started.

In the description, document information is illustrated as management target information (information to be managed), document data and information concerning the document data are illustrated as element information in the management target information, and document data is illustrated as element information of deletion target (element information to be deleted). The reason why the deletion target is the document data is that the possibility that the document data may have a larger storage capacity than any other element information in the document information is high.

An information processing apparatus 100 of the embodiment backs up, etc., document information in a document DB 160 and has a command acceptance module 105, a notification module 110, a search module 115, a backup module 120, a document data deletion mode 125, a document data conversion module 130, a processing determination module 135, a document processing module 140, a restoration module 145, an access right information comparison module 150, an access right information change detection flag setting module 155, the above-mentioned document DB 160, a buffer module 165, a record media R/W module 170A, and a record media R/W module 17013, as illustrated in FIG. 1.

As processing of outputting document information recorded in first record unit to second record unit, for example, backup processing and archive processing exist; in the embodiment, the backup processing will be mainly discussed. The backup processing is processing performed for continuation of system operation (fault recovery); the archive processing is processing performed for maintaining or referencing information for a long term.

The command acceptance module 105 accepts a command of backup processing of document information and a processing command of restoration of the backed-up document information, edit of the document information, etc., in response to operation of a keyboard, a mouse, etc., by the user. The document information to be processed as edit, etc., may be document information not backed up or may be post-backed-up document information. As a backup processing command of document information, search formula of document information may be contained as the specification format of the target document information. For example, a search formula of “creation date is before Dec. 31, 2000” may be used.

The notification module 110 notifies the user of the processing result, etc., of the processing determination module 135, etc., through a display, a loudspeaker, etc. For example, if it is determined that at least one of element information required for execution of processing (for example, document data) is not recorded in the document DB 160, the user is notified that the processing can not be performed. In other words, if the processing determination module 135 determines that “processing can not be performed without the document data,” the user is notified that the processing can not be performed.

If a search formula is contained as a command of backup processing accepted by the command acceptance module 105, the search module 115 searches the document DB 160 for document information stored therein based on the search formula. Accordingly, the document information to be backed up is determined.

The backup module 120 outputs document information stored in the document DB 160 to a record medium 175A of record means of backup destination. The document information to be backed up may be information determined by the search module 115. Information recorded in the record medium 175A may contain document data, document name, access right information, etc., and entire document information may be recorded.

If the access right information comparison module 150 determines that access right information differs, the backup module 120 replaces access right information in document information recorded in the record medium 175A of the record means of the backup destination with access right information recorded in the document DB 160, and outputs the document information to a record medium 175B (record medium different from the record medium 175A and newly created).

If the access right information comparison module 150 determines that access right information differs, when outputting element information (for example, document data, access right information, etc.) contained in the document information recorded in the record medium 175A to the buffer module 165, the backup module 120 replaces the access right information recorded in the record medium 175A with the access right information recorded in the document DB 160, and outputs the information to the buffer module 165. In other words, if the access right information comparison module 150 determines that access right information differs, the access right information in the document information recorded in the record medium 175A of the record means of the backup destination is replaced with the access right information recorded in the document DB 160, and outputs the document information to the buffer module 165. If the access right information change detection flag setting module 155 does not set an access right information change flag, control is performed so as not to output to the buffer module 165. If the access right information comparison module 150 determines that access right information does not differ, the document information recorded in the record medium 175A may be output to the buffer module 165. Next, if the access right information change detection flag setting module 155 sets the access right information change flag, the document information recorded in the buffer module 165 may be output to the record medium 175B.

The document data deletion mode 125 deletes document data in the document information backed up in the record medium 175A from the document DB 160 after the document information is copied by the backup module 120. Only the document data is deleted from the document information and attribute information, etc., in the document information is left.

When the backup module 120 copies the document information into the record medium 175A of the record means of the backup destination, the document data conversion module 130 converts the document data in the document information into document data in a predetermined format. The predetermined format is PDF/A (Portable Document Format/Archive), etc., for example. The backup module 120 copies the document information of the document data provided by the document data conversion module 130 into the record medium 175A of the record means of the backup destination.

When a processing command for document information is accepted from the user, the processing determination module 135 determines whether or not element information (for example, document data) contained in document information which is necessary for execution of the processing. In other words, the processing determination module 135 determines whether or not processing based on the command accepted by the command acceptance module 105 is processing for the document information with document data deleted by the document data deletion mode 125, and is processing that can be performed without the document data of the document information. Specifically, for example, display of the document attribute of document information, display of a thumbnail image, etc., applies as the processing that can be performed without the document data.

If the processing determination module 135 determines that element information (for example, document data) which is necessary for execution of the processing is recorded in the document DB 160, the document processing module 140 executes the processing. In other words, if the processing determination module 135 determines that the processing is processing that can be performed without the document data, the document processing module 140 executes the processing. For example, the document processing module 140 performs display of the document attribute of document information, display of a thumbnail image, etc. Of course, it also performs processing for document information not backed up. The processing may be edit, translation, etc., as well as display.

The restoration module 145 outputs the document information recorded in the record medium 175A of the record means of the backup destination to the former document DB 160 (restoration processing). The record medium 175A records at least the document ID and document data, and the document data read from the record medium 175A is restored to the document DB 160 through the document ID. Information for associating the document data recorded in the record medium 175A and the document information in the document DB 160 with each other is not limited to the document ID and when the backup module 120 records data in the record medium 175A, dedicated identification information may be given to both.

If access right information indicating whether or not to permit access to the document information is contained as element information contained in the document information, the access right information comparison module 150 determines whether or not the access right information contained in the document information recorded in the document DB 160 and the access right information contained in the document information recorded in the record medium 175A differ. In other words, the access right information comparison module 150 determines whether or not the access right information in the document information recorded in the document DB 160 and the access right information in the document information recorded in the record medium 175A of the record means of the backup destination differ.

The access right information is information indicating whether or not to permit access to the document information and can be one of element information of the document information. More specifically, it determines the subject (for example, user) that can perform predetermined operation for document information (edit, view, etc.) and makes it possible to control so that only the subject can perform the operation for the document information. As a specific example, the operation permitted for the document information and the user are associated with each other. Therefore, in a state in which the user has the access right, if the user attempts to operate the document information, the operation is permitted.

The case where the access right information comparison module 150 performs processing will be discussed. For example, document information may be transferred to another information processing apparatus 100 as required. To retain document information for a long term, it is also assumed that the access right information to the document information may be changed during the long-term retention. At least the document ID, the document data, and the access right information are recorded in the record medium 175A of the backup destination.

Assume that the access right information to the document information to be recorded in the record medium 175A is as follows:
User A: Readable
User B: Readable

When a term has elapsed since the information was recorded in the record medium 175A, it is assumed that user C is the successor to the user B. In this case, the access right information in the document DB 160 is changed as follows:
User A: Readable
User C: Readable

The content recorded in the record medium 175A remains intact at the record time, of course. Therefore, the access right information in the document DB 160 and the access right information in the record medium 175A differ.

In this state, if the record medium 175A is used to register the document information in new information processing apparatus 100, the change can not be reflected.

Then, another record medium on which the change is reflected is created.

However, if the current information processing apparatus 100 is commanded to again create the record medium (backup processing), document data of document information is deleted from the document DB 160 and thus if a transition is made to another information processing apparatus 100, the deleted document data can not be transferred.

Then, to create a record medium on which the change is reflected, both the document information in the current information processing apparatus 100 and the document information already recorded in the record medium 175A is necessary.

If the access right information comparison module 150 determines that the access right information differs, the access right information change detection flag setting module 155 sets an access right information change flag indicating that the access right information has been changed. Setting the access right information change flag means that the access right information has been changed; not setting the access right information change flag means that the access right information is not changed.

The document DB 160 stores document information. The document information includes document data and information concerning the document data. The document data is electronic data indicating the content of the document; for example, it contains text data or electronic data of an image, a moving image, a sound, etc., or a combination thereof depending on the situation and may be a target of processing of storage, edit, etc. The information concerning the document data in the document information may contain at least identification information for uniquely identifying the document information in the document DB 160 and the record medium 175A of the record means of the backup destination in addition to the document ID (Identification) for uniquely identifying the document information. Specifically, for example, items stored in a document information table 200 apply.

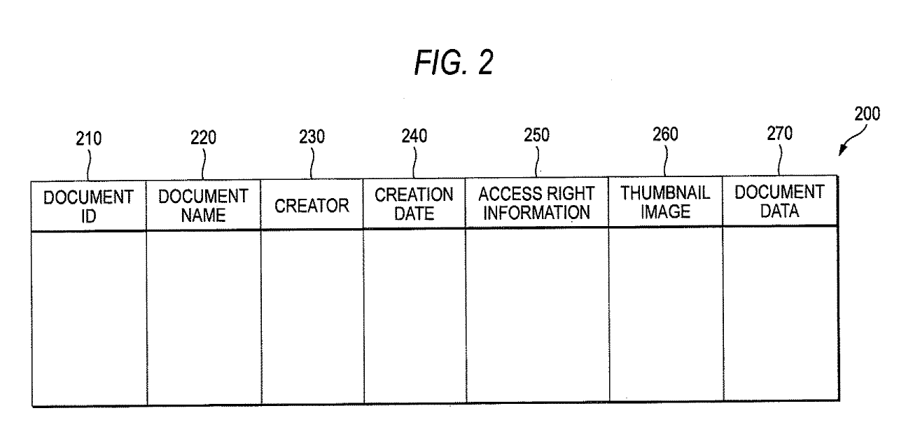

FIG. 2 is a schematic representation to show a data structure example of the document information table 200. The document information table 200 has a document ID column 210, a document name column 220, a creator column 230, a creation date column 240, an access right information column 250, a thumbnail image column 260, and document data 270.

The document ID column 210 stores the document ID for uniquely identifying the document information.

The document name column 220 stores the name of the document information.

The creator column 230 stores the user creating the document information (for example, the user ID, etc.).

The creation date column 240 stores the date on which the document information was created (for example, years months days; time, etc., may be contained).

The access right information column 250 stores the access right information set for the document information.

The thumbnail image column 260 stores a thumbnail of document data in the document information. For example, it is used to display the document data, etc. Not only the thumbnail, but also the address (URL (Uniform Resource Locator), etc.) at which the thumbnail is stored may be stored.

The document data 270 stores the document data. If the document data is deleted by backup processing, a code indicating it is stored. Not only the document data, but also the address at which the document data is stored (URL, etc.) may be stored.

The buffer module 165 temporarily stores document information. For example, it is used to output to the record medium 175E using the document information stored in the document DB 160 or the record medium 175A.

The record media R/W module 170A outputs or reads document information to or from the record medium 175A.

The record media R/W module 170B outputs or reads document information to or from the record medium 175B. The record medium 175A, etc., is an example of the record means of the backup destination; the record means of the backup destination is not limited to record medium and may be a hard disk or a hard disk, etc., in another information processing apparatus 100.

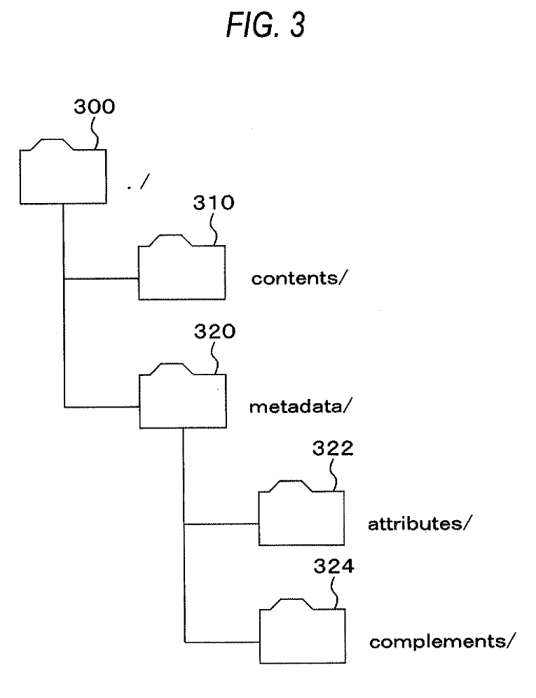

The document information stored in the record media R/W module 170A, etc., has a tree structure. The backup module 120 converts information into the tree structure. For example, FIG. 3 is a schematic representation to show a data structure example of an output destination folder 300.

The output destination folder 300 has a document data folder 310 and a metadata information folder 320. The document data folder 310 stores document data, and the metadata information folder 320 stores attribute information, etc.

The metadata information folder 320 has an attribute information folder 322 and a complement information folder 324. The attribute information folder 322 stores the document ID, the access right information, etc., and the complement information folder 324 stores information other than the attribute information (for example, information concerning the edit state of the document information or the like).

The backed-up document information is managed according to storage location information 400 indicating which record medium the information is recorded in. The storage location information 400 is generated by the backup module 120.

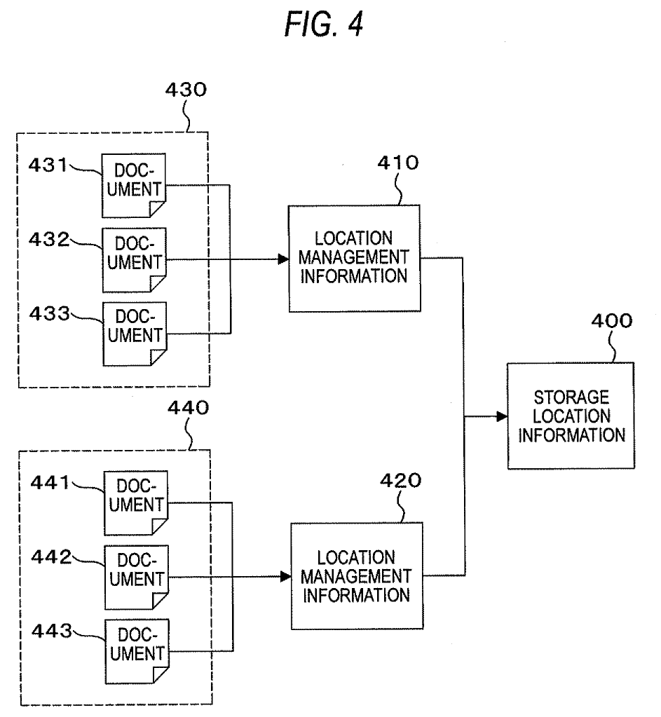

FIG. 4 is a schematic representation to show a data structure example of the storage location information 400. A document 431, etc., backed up in one record medium exists as a backup unit 430 (440). As location management information 410 (420) concerning the record medium, a location management label, an administrator, description, record media information, a storage location, and the like exist. The name, description, region classification, and the like exist as the storage location information 400. The storage location information 400, the location management information 410, and the like form a tree structure, and the location management information 410 (420) exists under the storage location information 400.

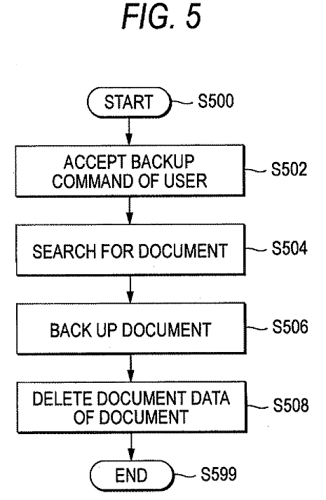

FIG. 5 is a flowchart to show a backup processing example according to the embodiment.

At step S502, the command acceptance module 105 accepts a backup command of the user.

At step S504, the search module 115 searches the document DB 160 for the corresponding document based on a search formula in the accepted command.

At step S506, the backup module 120 backs up the corresponding document, namely, copies the document information from the document DB 160 into the record medium 175A. After the document data conversion module 130 converts the document data to be copied, the data may be copied into the record medium 175A.

At step S508, the document data deletion mode 125 deletes the document data of the document copied into the record medium 175A.

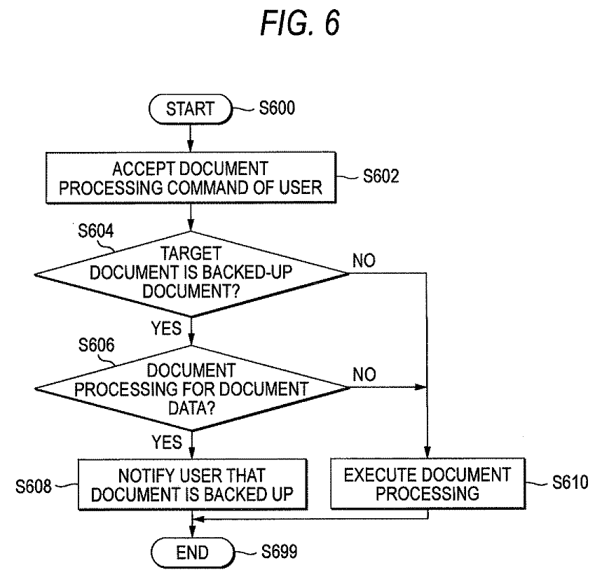

FIG. 6 is a flowchart to show a document processing example according to the embodiment.

At step S602, the command acceptance module 105 accepts a document processing command of the user.

At step S604, the processing determination module 135 determines whether or not the target document information is backed-up document information, for example, depending on whether or not a code indicating that the document data is deleted by backup processing exists in the document data 270 in the document information table 200. If the document information is backed-up document information (the document data is deleted), the process goes to step S606; otherwise, the process goes to step S610.

At step S606, the processing determination module 135 determines whether or not processing is document processing for the document data, for example, depending on whether or not the specified document processing can be performed only with attribute information, etc., other than the document data. If the processing is document processing for the document data (processing of displaying the document data, etc.), the process goes to step S608; otherwise (if the processing is display processing of access right information, thumbnail display processing, etc.), the process goes to step S610.

At step S608, the notification module 110 notifies the user that the document information is backed up (namely, processing can not be performed). Further, if the user wants to perform the document processing using the storage location information 400, the location management information 410, etc., the location management label, etc., of the record medium recording the document data may be indicated.

At step S610, the document processing module 140 executes the specified document processing. That is, if the processing requested by the user is processing that can be executed without document data, processing is executed not only for document information with document data, but also for the backed-up document information.

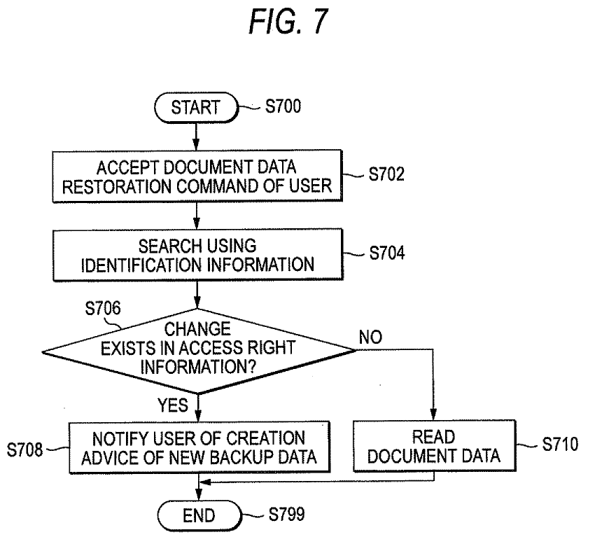

FIG. 7 is a flowchart to show a restoration processing example according to the embodiment.

At step S702, the command acceptance module 105 accepts a document data restoration command of the user.

At step S704, the restoration module 145 searches using identification information, namely, determines the record medium 175A of the record means of the backup destination and searches the record medium for the document information recorded therein and the document information in the document DB 160 corresponding to the document information using the identification information.

At step S706, the access right information comparison module 150 determines whether or not change exists in access right information about both the document information pieces. If change exists, the process goes to step S708; otherwise, the process goes to step S710.

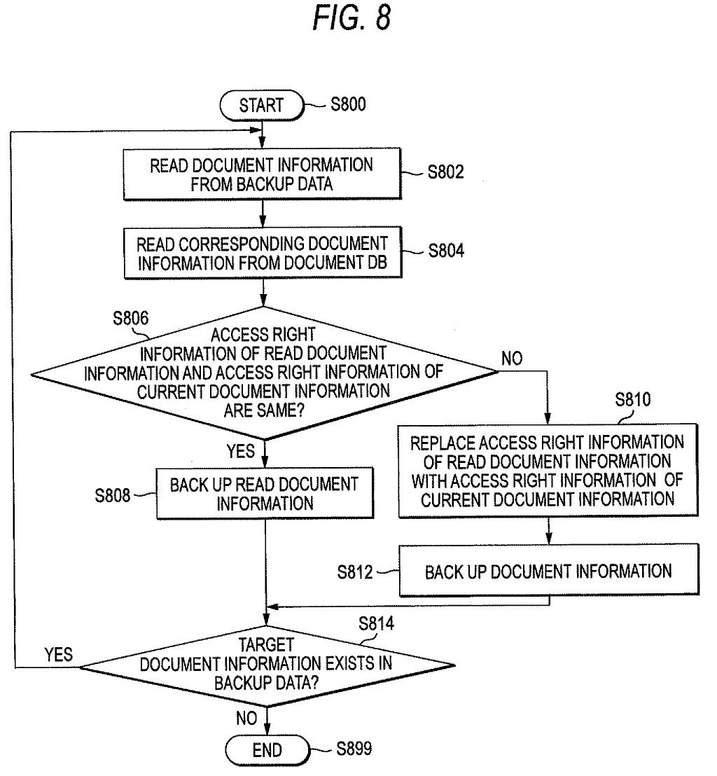

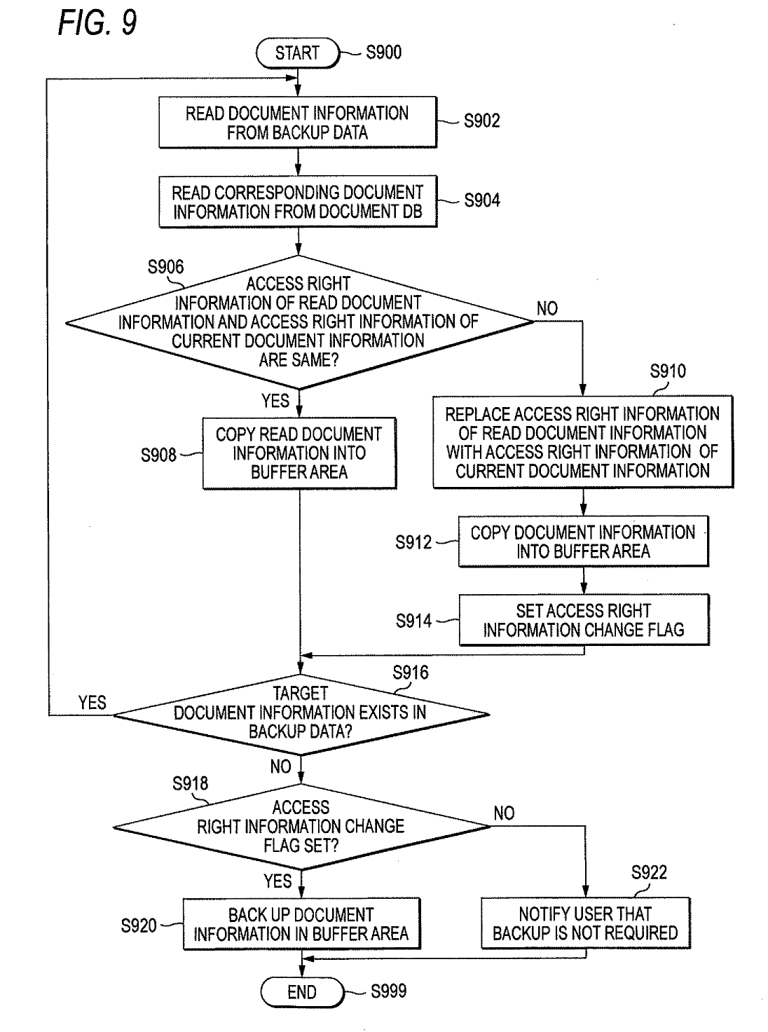

At step S708, the notification module 110 notifies the user of a creation advice of new backup data. That is, after backup processing is performed, the access right information is changed and the case is the case not fitted for restoration as it is. Thus, the user is prompted to perform processing according to a flowchart illustrated in FIG. 8 or FIG. 9 described later. That is, the user is prompted to create new backup data and restore data from the new backup data.

At step S710, the restoration module 145 reads document data from the record medium 175A into the document DB 160.

FIG. 8 is a flowchart to show a backup processing example when the access right information is changed according to the embodiment.

At step S802, the backup module 120 reads document information one piece at a time from the backup data in the record medium 175A.

At step S804, the backup module 120 reads the corresponding document information from the document DB 160.

At step S806, the access right information comparison module 150 determines whether or not the access right information of the read document information (step S802) and the access right information of the current document information (step S804) are the same. If they are the same (if the access right information is not changed), the process goes to step S808; otherwise, the process goes to step S810.

At step S808, the backup module 120 backs up the document information read at step S802 in the record medium 175B.

At step S810, the backup module 120 replaces the access right information of the document information read at step S802 with the access right information of the current document information (step S804).

At step S812, the backup module 120 backs up the document information in the record medium 175B.

At step S814, the backup module 120 determines whether or not the target document information exists in the backup data in the record medium 175A. If the target document information exists, the process returns to step S802; otherwise, the processing is terminated (step S899).

The record medium 175A and the record medium 175B may be different media or may be the same media.

FIG. 9 is a flowchart to show a backup processing example when the access right information is changed according to the embodiment. In this example, the record medium 175A and the record medium 175B are different media

Steps S902 to S906 are similar to steps S802 to S806 in the flowchart illustrated in FIG. 8.

At step S908, the backup module 120 copies the read document information into a buffer area in the buffer module 165.

Step S910 is similar to step S810 in the flowchart illustrated in FIG. 8.

At step S912, the backup module 120 copies the document information into a buffer area in the buffer module 165.

At step S914, the access right information change detection flag setting module 155 sets the access right information change flag.

At step S916, the backup module 120 determines whether or not the target document information exists in the backup data. If the target document information exists, the process returns to step S902; otherwise, the process goes to S918.

At step S918, the backup module 120 determines whether or not the access right information change flag is set. If the flag is set, the process goes to step S920; otherwise, the process goes to step S922.

At step S920, the backup module 120 backs up the document information in the buffer area in the buffer module 165 in the record medium 175B.

At step S920, the notification module 110 notifies the user that backup is not required. Of course, in this case, backup processing is not performed. That is, if the access right information change flag is not set (the determination at step S906 is not NO), the backup module 120 controls so as not to back up information.

In the flowchart example, at step S908 and step S912, information is copied into the buffer area in the buffer module 165. However, in the loop after step S906, steps S908, S910, and S912 may be skipped. That is, when step S906 is executed, if the determination at step S906 is NO, step S914 is executed; if the determination at step S906 is YES, step S916 is executed. Next, if the determination at step S918 is YES (namely, at the position at step S920), steps S902 to S916 except S914 may be repeated. In this case, the document information is backed up in the record medium 175B without using the buffer area in the buffer module 165.

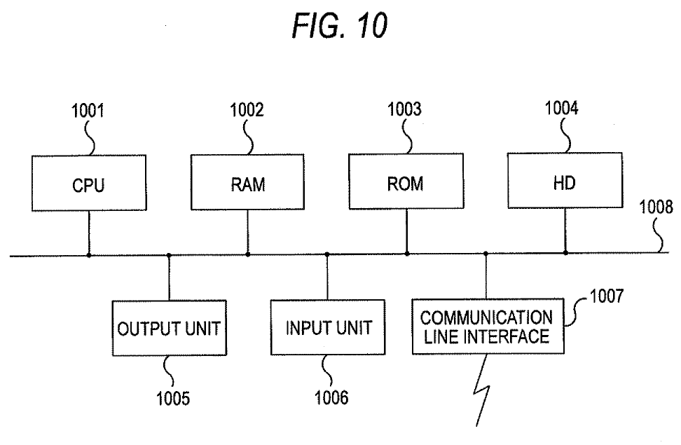

The hardware configuration of a computer for executing a program as the embodiment is a general computer as illustrated in FIG. 10; specifically it is a personal computer, a computer that can become a server, or the like. That is, as a specific example, a CPU 1001 is used as a processing section (computation section) and RAM 1002, ROM 1003, and an HD 1004 are used as storage. For example, a hard disk may be used as the HD 1004. The hardware configuration is made up of a CPU 1101 for executing the programs of the search module 115, the backup module 120, the document data deletion mode 125, the document data conversion module 130, etc., RAM 1002 for storing the programs and data, ROM 1003 storing a program for starting the computer and the like, the above-mentioned HD 1004 of auxiliary storage, an input unit 1006 for entering data such as a keyboard or a mouse, an output unit 1005 of a CRT, a liquid crystal display, etc., a communication line interface 1007 for connecting to a communication network, such as a network interface card, and a bus 1008 for connecting the components for transferring data. Two or more computers may be connected by a network.

For the part based on the computer program in the embodiment described above, the computer program of software is read into the system of the hardware configuration and the software and hardware resources work in cooperation, thereby implementing the embodiment described above.

The hardware configuration shown in FIG. 10 shows one configuration example and the embodiment is not limited to the configuration in FIG. 10 and any configuration may be adopted if it makes it possible to execute the modules described in the embodiment. For example, some modules may be implemented as dedicated hardware (for example, an ASIC, etc.) and some modules may be included in an external system and may be connected via a communication line and further a plurality of systems shown in FIG. 10 may be connected via a communication line so as to operate in cooperation with each other. The system may be built in a home information appliance, a copier, a fax, a scanner, a printer, a multiple function device (an image processing apparatus having two or more functions of a scanner, a printer, a copier, a fax, and the like), etc., in addition to a personal computer.

In the embodiment described above, the backup processing has been shown, but the embodiment may be applied to archive processing.

The described program may be provided as it is stored on a record medium or the program may be provided by communication means. In this case, for example, the described program may be grasped as the invention of a computer-readable record medium recording a program.”

The expression “computer-readable record medium recording a program” is used to mean a record medium read by a computer recording a program, used to install and execute a program, to distribute a program, etc.

The record media include “DVD-R, DVD-RW, DVD-RAM, etc.,” of digital versatile disk (DVD) and standard laid down in DVD Forum, “DVD+R, DVD+RW, etc.,” of standard laid down in DVD+RW, read-only memory (CD-ROM), CD recordable (CD-R), CD rewritable (CD-RW), etc., of compact disk (CD), Blue-ray Disc (registered trademark), magneto-optical disk (MO), flexible disk (FD), magnetic tape, hard disk, read-only memory (ROM), electrically erasable and programmable read-only memory (EEPROM), flash memory, random access memory (RAM), etc., for example.

The described program or a part thereof may be recorded in any of the described record media for retention, distribution, etc. The described program or a part thereof may be transmitted by communications using a transmission medium such as a wired network used with a local area network, a metropolitan area network (MAN), a wide area network (WAN), the Internet, an intranet, an extranet, etc., or a wireless communication network or a combination thereof, etc., for example, and may be carried over a carrier wave.

Further, the described program may be a part of another program or may be recorded in a record medium together with a different program. It may be recorded as it is divided into a plurality of record media. It may be recorded in any mode if it can be restored, such as compression or encryption.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable medium storing a program causing a computer to execute an information process, the information process comprising:
first outputting at least one piece of element information of management target information from a first record unit to a second record unit, the first and the second record units recording the management target information containing a plurality of pieces of element information;
deleting, from the first record unit, at least one piece of element information which is output to the second record unit;
determining, upon acceptance of a request for processing the management target information recorded in the first record unit from a user, whether or not element information which is necessary for execution of the processing is recorded in the first record unit; and
executing the processing if the element information which is necessary for execution of the processing is recorded in the first record unit.

2. The computer readable medium according to claim 1, the information process further comprising:
notifying the user that the processing can not be executed if the determination indicates that the element information which is necessary for execution of the processing is not recorded in the first record unit.

3. The computer readable medium according to claim 1,
wherein identification information for uniquely identifying the management target information in the first and the second record units is at least contained as the element information of the management target information.

4. The computer readable medium according to claim 1,
wherein the element information contained in the management target information includes access right information indicating whether or not to permit access to the management target information,
the information process further comprising:
if first access right information recorded in the first record unit is different from second access right information recorded in the second record unit,
(i) replacing the second access right information with the first access right information, and
(ii) outputting the element information recorded in the second record unit and the replaced access right information to a third record unit.

5. The computer readable medium according to claim 4, the information process further comprising:
setting change information showing that the access right information is changed if the first and the second access right information differ from each other; and
controlling such as the second output is not performed if the change information is not set.

6. An information processing method comprising:
first outputting at least one piece of element information of management target information from a first record unit to a second record unit, the first and the second record units recording the management target information containing a plurality of pieces of element information;
deleting, from the first record unit, at least one piece of element information which is output to the second record unit;
determining, upon acceptance of a request for processing the management target information recorded in the first record unit from a user, whether or not element information which is necessary for execution of the processing is recorded in the first record unit; and
executing the processing if the element information which is necessary for execution of the processing is recorded in the first record unit.

7. The information processing method according to claim 6,
wherein the element information contained in the management target information includes access right information indicating whether or not to permit access to the management target information,
the information process further comprising:
if first access right information recorded in the first record unit is different from second access right information recorded in the second record unit,
(i) replacing the second access right information with the first access right information, and
(ii) outputting the element information recorded in the second record unit and the replaced access right information to a third record unit.

8. An information processing apparatus comprising:
a first output unit that outputs at least one piece of element information of management target information from a first record unit to a second record unit, the first and the second record units recording the management target information containing a plurality of pieces of element information;
a deletion unit that deletes, from the first record unit, at least one piece of element information which is output to the second record unit by the first output unit;
a determination unit, upon acceptance of a request for processing the management target information recorded in the first record unit from a user, the determination unit for determining whether or not element information which is necessary for execution of the processing is recorded in the first record unit; and
a processing unit that executes the processing if the determination unit determines that the element information which is necessary for execution of the processing is recorded in the first record unit.

9. The information processing apparatus according to claim 8,
wherein the element information contained in the management target information includes access right information indicating whether or not to permit access to the management target information,
the information processing apparatus further comprising:
if first access right information recorded in the first record unit is different from second access right information recorded in the second record unit,
a second outputting unit that (i) replaces the second access right information with the first access right information, and (ii) outputs the element information recorded in the second record unit and the replaced access right information to a third record unit.
